(19) United States
(12) Patent Application Publication
(10) Pub. No.: US 2006/0219462 A1
(43) Pub. Date: Oct. 5, 2006

(54) Forward frame part for a utility vehicle

(76) Inventors: Gerd Martin, Stuttgart (DE); Wilhelm Stockklausner, Plochingen (DE)

Correspondence Address: KENYON & KENYON LLP, ONE BROADWAY, NEW YORK, NY, 10004, US

(21) Appl. No.: 10/541,919

(22) PCT Filed: Dec. 16, 2003
(86) PCT No.: PCT/EP03/14309

§ 371 Date: Apr. 7, 2006

(30) Foreign Application Priority Data
Jan. 9, 2003 (DE) 103003932

(51) Int. Cl. B60K 5/00

(52) U.S. Cl. 180/292

(57) ABSTRACT

A forward frame part for a utility vehicle, which may be connected to two longitudinal members of a vehicle supporting frame and includes a front cross member with a cross-member upper and lower part, of which the lower part is used as an underride guard, and also fastening elements for the connection to the two longitudinal members, includes a multiplicity of simply constructed identical parts in the manner of a module in order to be able to be used in different configurations for utility vehicles dimensioned differently in the front region. The forward frame part includes, e.g., a front and rear main module, it being possible for the rear main module to be used unchanged with regard to different front region variants of utility vehicles with merely the front main module being adapted.

### FIELD OF THE INVENTION

The present invention relates to a forward frame part for a utility vehicle.

### BACKGROUND INFORMATION

A forward frame part of this type is described in German Published Patent Application No. 44 28 101. This forward frame part includes individual structural elements which are put together, with essentially completely different forward frame parts being required in each case for different vehicle variants.

### SUMMARY

An example embodiment of the present invention may provide forward frame parts for utility vehicles, with which, with the use of as many simply constructed identical parts as possible, different vehicle variants may be equipped with correspondingly different forward frame parts.

According to an example embodiment of the present invention, the forward frame part may be constructed from a front and rear main module, of which the rear main module may be used unchanged in terms of components for vehicle variants which are different in the front region, whereas the front main module may be easily adapted to different vehicle variants with as few individual elements as possible which may be produced in a simple manner being interchanged. In addition, all of the individual components of the module may be able to be produced in a simple manner and, for this purpose, include shaped sheet metal, simple profiles, cast parts, etc. In addition, the individual elements of the main modules and the two modules may be arranged such that they may be connected to one another by bolted connections which may be fitted and removed in a simple manner. In the event of repair, bolted individual module elements may easily be interchanged. All of the parts of an individual wheel suspension, including parts of the steering system, are attached to the rear main module with the chassis underframe, as a result of which the individual wheel suspension may be preassembled and adjusted on the rear main module or may be attached in the preassembled and adjusted state.

The modular arrangement may make it possible for different vehicle variants, such as road vehicles, low frame vehicles, low-liner vehicles, construction site vehicles, low-floor vehicles, implement-carrier vehicles, etc., for different individual wheel suspensions for not all-wheel drive and all-wheel drive vehicles to easily be produced.

The individual parts of the main modules may be formed from a few simple parts which are partly identical and may be manufactured worldwide (edge parts, tubular profiles, cast parts; i.e., no pressed parts).

The front cross member may include an upper and lower cross-member part, the two cross-member parts being simple profiled members. The cross-member parts are connected to one another in the side region by being joined to lateral forward frame longitudinal members.

The forward frame longitudinal members have a built-up structure and in each case include a top and bottom cord, these two cords, connected by web plates, forming a supporting structural part. Top cord, bottom cord and web plates differ in height and length depending in each case on the different front main module, but in principle are of identical design. By a large surface-layer zone distance between top cord and bottom cord, a very flexurally rigid and lightweight member may be achieved in each case.

The top cord includes an L-angled profile and has the function of absorbing and passing on towing forces and driver's-cab mounting forces.

The connection of top cord to bottom cord is achieved by lateral web plates which differ in height and length depending in each case on the module and which are connected, e.g., bolted, at the top to the top cord by spacer elements and at the bottom directly to the bottom cord. The towing forces and driver's-cab mounting forces are conducted into an, e.g., cast corner piece which is arranged at the front end of the top cord and is bolted between the web of the angled profile of the top cord and the web plate. The web of the top cord and the vertical web plate thereby form a sandwich element which may have a very great flexural rigidity about the vertical axis and may very readily absorb and pass on the driver's-cab mounting forces and towing forces.

The corner piece for absorbing the driver's-cab mounting forces, towing forces and the upper cross-member part of the front cross member is identical for all vehicle variants of a prespecifiable vehicle group. The shape of the corner piece is selected such that it is symmetrical to a central plane which in turn extends parallel to the carriageway. This may enable the same corner piece to be used on the left and right sides of the front main module.

The top cord is joined to the vehicle frame longitudinal members at different positions depending in each case in the type of module. For road vehicles, low frame vehicles, low-liner vehicles, construction site vehicles, implement-carrier vehicles, etc., the joining takes place in an upper region of the vehicle longitudinal member. For vehicles with, for example, a lowered driver's cab, the top cords of the front main module are bolted at the bottom to the longitudinal members of the vehicle frame in order to provide the necessary clearance between driver's cab and frame.

The bottom cord has the function of absorbing and passing on forces and torques which are produced by underride guard forces, which are introduced laterally into the respectively assigned longitudinal members of the vehicle frame and act on the lower cross-member part, and the bottom cord may be arranged as a crash element.

The bottom cords are joined to the rear main module in each case via an, e.g., cast torque support to which also the lower longitudinal link of a front-axle individual wheel suspension is joined. Depending in each case on the arrangement of the individual wheel suspension in a not all-wheel drive design or an all-wheel drive design, the bottom cord is bolted in different heights to this longitudinal link part, which may be arranged as a cast part. As a result, with an identical front and rear main module part, different distances of the individual wheel suspension from the chassis frame may be produced for not all-wheel drive vehicles or all-wheel drive vehicles.

A left and right torque support are connected by a transverse tube and a transverse thrust plate for supporting torques or transverse forces. The torque supports, the transverse tube and the transverse thrust plate, which, when connected, form a type of bracket for absorbing torques of the underride guard forces, may be identical for all vehicles. The abovementioned transverse thrust plate may represent a special arrangement of the plate-like connecting part hereof.

The introduction of the longitudinal forces from the front main module part into the rear main module part, including from the longitudinal members of the vehicle frame, takes place via the following structural features:
a) the respective L-profile of the longitudinal-member top cords,
b) a first, vertically arranged thrust plate as upper side member of the main module, which is bolted laterally onto the respectively assigned longitudinal member of the vehicle frame. This thrust plate may be identical for all types of vehicle which are to be varied and all axle arrangements of a selected vehicle group with not all-wheel drive or all-wheel drive. For the different axle arrangements, the vertical thrust plate is connected to the chassis underframe in different height positions by the torque support, which is used as a longitudinal link part of an individual wheel suspension,
c) a second, vertically arranged thrust plate as lower side member of the rear main module, which has the function of a stabilizer-bar mounting. This thrust plate connects the torque support (longitudinal link part), including longitudinal link part, to the chassis underframe and may be identical for all vehicle types. It may be removed for exchanging the stabilizer bar or the individual wheel suspension device without the joining of the main modules having to be released.

The introduction of torque from the front main module to the rear main module of the forward frame part takes place about the transverse axis of the vehicle via a large distance base of the top cord of the front main module from the lower joining points of the thrust plates as side members. When the parts are bolted to one another, the stressing of the bolts may be overall relatively low.

The forward frame longitudinal members, which are arranged as sandwich elements, and a thrust plate, which is arranged at the bottom parallel to the carriageway and is in the form of a plate-like connecting part, take on the transverse supporting of the front main module.

Example embodiments of the forward frame part are illustrated in the appended Figures.

### BRIEF DESCRIPTION OF THE DRAWINGS

FIG. 1 is a perspective exploded view of a forward frame part including a front and rear main module.

FIG. 2 is an assembled view of the exploded view illustrated in FIG. 1.

FIG. 3 illustrates the forward frame part illustrated in FIGS. 1 and 2 in various views.

FIG. 4 illustrates a forward frame part with a front main module which has been modified in comparison to that illustrated in FIGS. 1 to 3.

FIG. 5 illustrates a forward frame part with a front main module part which has been modified.

FIG. 6 is a comparative view of three forward frame parts with different front main modules with an identical rear main module.

### DETAILED DESCRIPTION

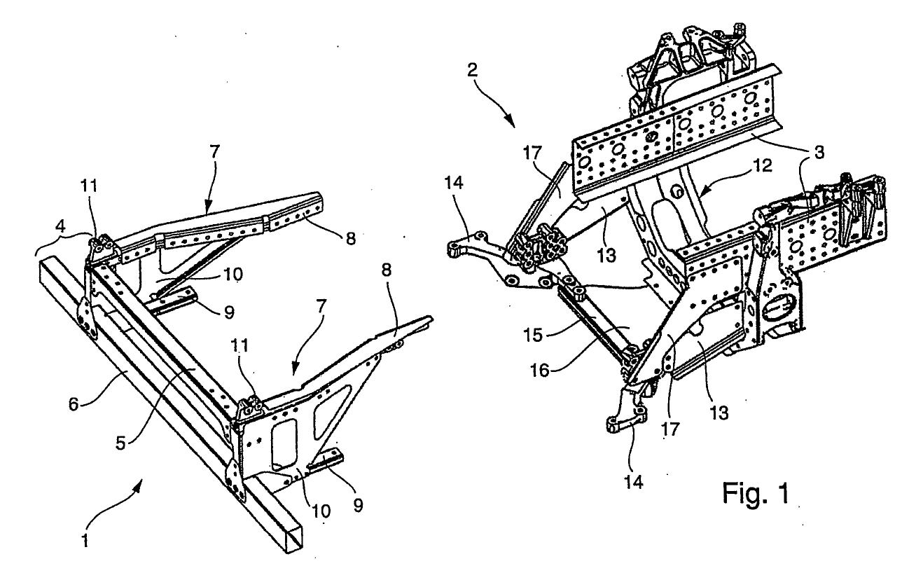

Example embodiment illustrated in FIGS. 1 to 3:

A forward frame part of a utility vehicle includes a front and rear main module 1; 2, of which the rear main module 2 is connected to the longitudinal members 3 of the vehicle frame, e.g., by a bolted connection.

The front main module includes a front cross member 4 with an upper cross-member part 5 and a lower, lower cross-member part 6 which carries out the function of an underride guard, and lateral forward frame longitudinal members 7 which are bolted fixedly to the front cross member 4.

The forward frame longitudinal members 7 include a top cord 8 in the form of an L-profile of shaped sheet metal, a bottom cord 9 including a simple member profile, and connecting side thrust plates 10. Top cord 8 and bottom cord 9 are connected to the side thrust plates 8 to form a rigid supporting structure. The front cross-member parts 5, 6 are bolted to the front side of the side thrust plates 10, which side is arranged toward the front side of the vehicle, as a result of which a composite part which is capable of being load-bearing is achieved with regard to the front cross member 4. In the case of the forward frame longitudinal members 7, either in each case only one of the top and bottom cords 8, 9 with the side protection plate 11 arranged in between may be formed integrally or both cords 8, 9 may be formed integrally.

The connection between the ends of the upper cross-member part 5 and the adjacent ends of the top cords 8 takes place via in each case a stable, e.g., cast, corner piece 11 which has webs in the direction of the upper cross-member part 5 and the top cord 8, by which webs an overlapping region is provided between the upper cross-member part 5, on the one hand, and the top cord 8, on the other hand, when the connection has taken place in each case. The corner pieces 11 are arranged such that identical corner pieces may be used on the left and right. For this purpose, the corner pieces 11 may have an identical arrangement above and below a plane extending parallel to the carriageway, with the result that, depending in each case on the installation on the right or left, an identical corner piece arrangement upward may always be used as part of the driver's-cab mounting and towing device.

The free, downwardly protruding ends of the top and bottom cords 8, 9 are provided with fastening devices, for example fastening holes, for fastening the top cords 8 to the longitudinal members 3 of the vehicle frame and the bottom cord 9 to the rear main module 2.

The rear main module 2 includes the following individual module parts.

An approximately U-shaped chassis underframe 12 having a closed U-bow arranged at the bottom and approximately vertically upwardly protruding U-limbs supports torque supports 14 cast over lower side members 13—arranged in the form of thrust plates—which are bolted on in the lower region of the U-limbs. The torque supports 14 are connected, e.g., bolted, to each other in the transverse direction of the vehicle via a torque support connection 15 arranged as a cross member. The torque support connection 15 is connected to the closed U-bow of the chassis underframe 12 via a plate-like connecting part 16 arranged as a thrust plate. Furthermore, upper side members 17 which are arranged as thrust plates are connected fixedly, e.g., bolted, to the torque supports 14.

All of the parts of a front-axle individual wheel suspension may be fastened to the above-described rear main module 2, e.g., to the chassis underframe 12, including the torque supports 14 for accommodating links of the individual wheel suspension.

Together with a preassembled individual wheel suspension, the rear main module 2 may be bolted onto the longitudinal members 3, e.g., via the U-limbs of the chassis underframe 12, on the one hand, and the upper side members 17, on the other hand. Formed on the torque support 14 is a receiving hole pattern which may enable the rear main module 2 to be bolted at various heights onto the upper side members 17.

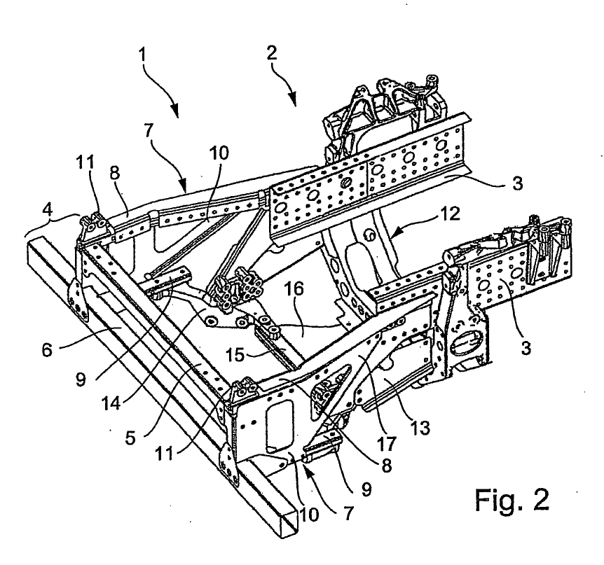

In the assembled state, which is illustrated in FIG. 2, of front and rear main modules 1, 2, the top cords 8 are bolted to the longitudinal members 3 and the bottom cords 9 are bolted to the torque supports 14.

By the bottom cords 9, which are bolted onto the lower cross-member part 6 and the torque support 14, a stable cross-member unit is produced with a thrust-zone-like stiffening of the forward frame part. This may result in an increased thrust and torsional strength of the forward frame. The frame-like arrangement when joined to the torque supports 14 means that underride guard forces may be reliably supported in terms of torque in the torque supports 14. Furthermore, a torque-free passing on of the underride guard forces via the side members 17 into the longitudinal members 3 may be ensured about the vertical axis of the vehicle. Transverse forces are passed directly via thrust to the chassis underframe 12 via the connecting thrust plate 16.

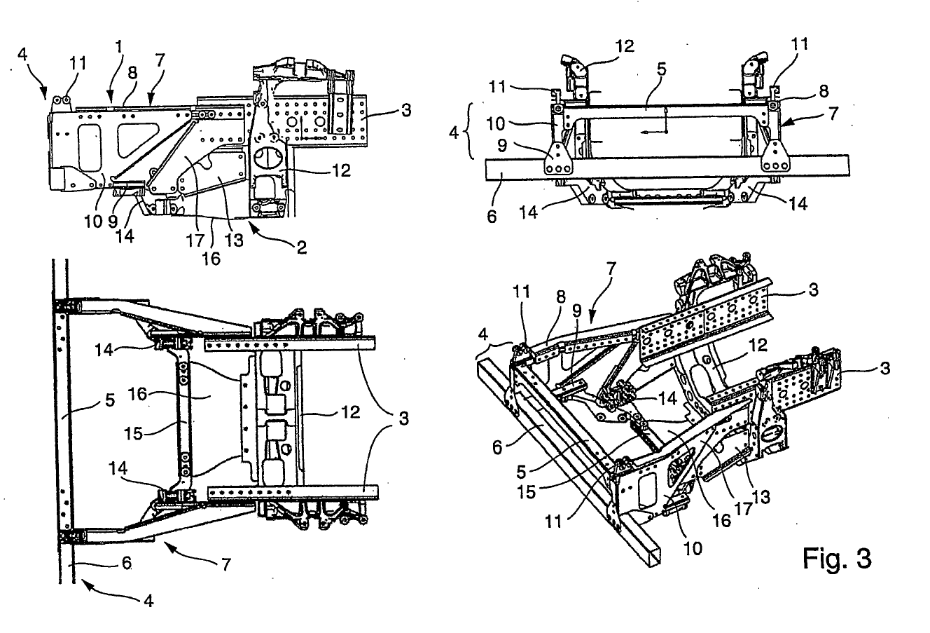

The above-described construction of the forward frame part may be seen clearly with regard to the illustration in FIG. 2 in various views in FIG. 3.

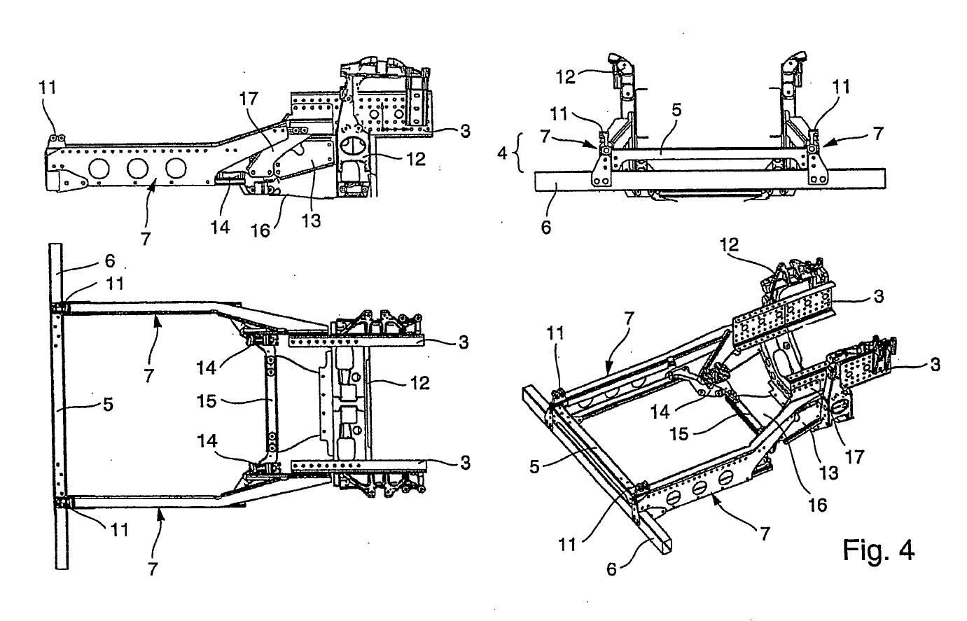

Example embodiment illustrated in FIG. 4:

The forward frame part illustrated in FIG. 4 has in principle the same construction as that illustrated in FIGS. 1 to 3 with a modified front main module 1. This front main module 1 has a longer forward frame longitudinal member 7 for a low-floor variant of a utility vehicle and, in addition, is bolted together with the rear main module 2 onto the longitudinal members 3 at a lower height with respect to the vertical axis of the vehicle than is the case in the example embodiment illustrated in FIGS. 1 to 3. Functionally identical parts are indicated in FIG. 4 by the same reference numbers as in FIGS. 1 to 3.

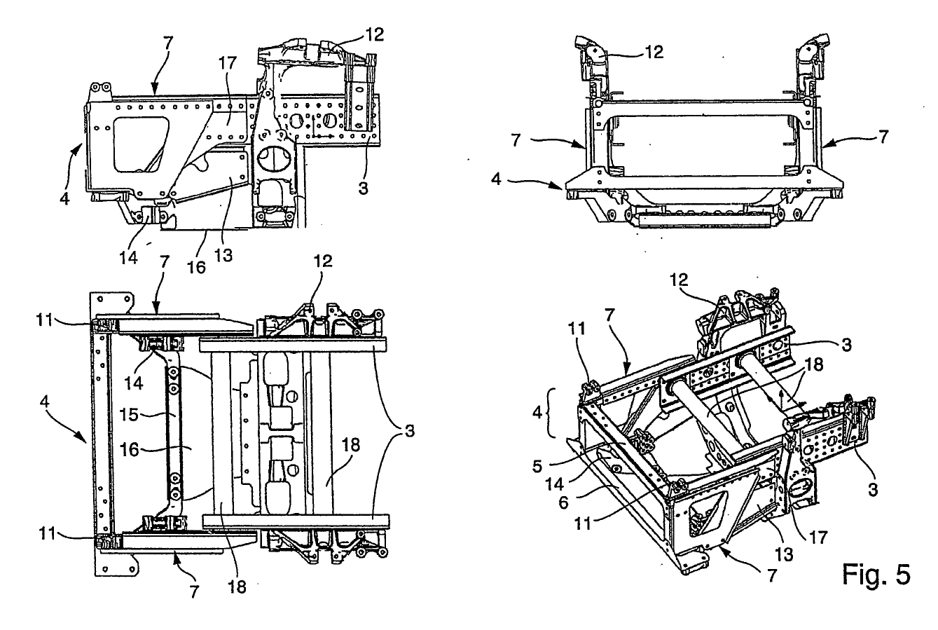

Example embodiment illustrated in FIG. 5:

This example embodiment concerns a “implement-carrier design” of a utility vehicle forward frame part. Here too, functionally identical components are again indicated by the same reference numbers as in the other Figures. A particular feature of this example embodiment is that the longitudinal members 3 are additionally stabilized in the region in which they are joined to the chassis underframe 12 additionally by stiffening members 18 arranged at a distance from and parallel to one another in the longitudinal direction.

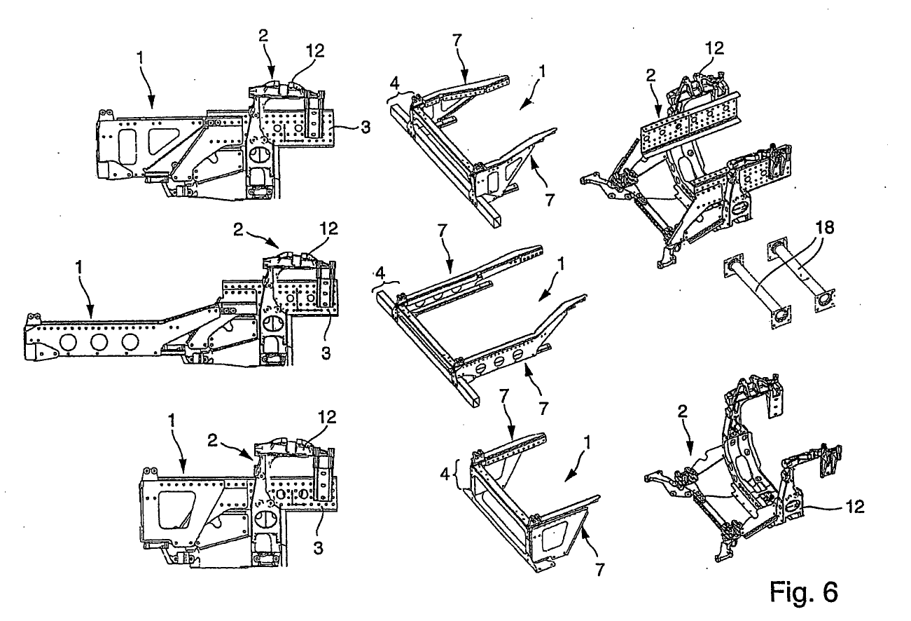

FIG. 6 shows a comparative illustration of the example embodiments illustrated in FIGS. 1 to 5. This illustration makes it clear that an identical rear main module 2 may be used in each case for all different vehicle variants and that also the few front main modules 1 for producing all of the vehicle variants may be, despite their different dimensions, firstly in principle of identical construction and secondly include a multiplicity of identical parts.

It should be understood that certain advantages may be achieved by the use of individual parts which may be produced in a simple manner and may be manufactured worldwide (edge parts, no pressed parts) and which, with the use of a multiplicity of identical parts, may be put together to form larger modules. All of the individual components, when connected by a bolted connection, may easily be removed and replaced in the event of repair.

1-9. (canceled)

10. A forward frame part for a utility vehicle connectible to two longitudinal members of a vehicle supporting frame, comprising:
a rear main module including a U-shaped chassis underframe having a closed U-bow arranged at a bottom and U-limbs extending in a vertical axis of the vehicle arranged for attachment of an individual wheel suspension device, the rear main module including lower side members connected on one side to the chassis underframe and including torque supports on a side opposite to the connection to the chassis underframe, the rear main module including a torque support connection and a connection part arranged between the torque support connection and a region of the chassis underframe located at a bottom;
a front main module including a front cross member and lateral forward frame longitudinal members joinable to the rear main module and the longitudinal members of the vehicle supporting frame, the front cross member including a cross-member upper part and a cross-member lower part; and
a joining module including two upper side members joinable at one end to the longitudinal members of the vehicle supporting frame and at another end to the torque supports;
wherein the rear main module is connectible via the chassis underframe and the upper side members to the longitudinal members of the vehicle supporting frame.

11. The forward frame part according to claim 10, wherein the connection part is in the form of a plate.

12. The forward frame part according to claim 10, wherein the cross-member upper part is connected at its ends by respective corner pieces to the lateral forward frame longitudinal members, the corner pieces arranged at least one of (a) as bearing mounts for a driver's cab and (b) as towing bearings, the corner pieces being identical and arranged for use on either side of a longitudinal axis of the vehicle by rotation of 180°.

13. The forward frame part according to claim 1, wherein the lateral forward frame longitudinal members are joined together from individual component parts, including a top cord and a bottom cord connected to each other by a side protection plate.

14. The forward frame part according to claim 13, wherein the top cord includes an L-profile.

15. The forward frame part according to claim 10, wherein the torque support includes a cast part.

16. The forward frame part according to claim 15, wherein the torque support is configured to support links of the individual wheel suspension device attached to the chassis underframe.

17. The forward frame part according to claim 10, wherein the side members include shaped plates.

18. The forward frame part according to claim 10, wherein the chassis underframe is connectible to the longitudinal members of the vehicle frame at different height positions to obtain different height positions in relation to the longitudinal members of the vehicle frame.

19. The forward frame part according to claim 10, wherein the upper side members are connectible to the torque supports in different height positions to obtain different height positions of the rear main module in relation to the longitudinal members of the vehicle frame.
